(19) United States
(12) Patent Application Publication
(10) Pub. No.: US 2005/0066814 A1
(43) Pub. Date: Mar. 31, 2005

(54) Apparatus and method for producing nitrox

(75) Inventor: Glenn Alan Huebner, Oxnard, CA (US)

Correspondence Address: James K. Dawson;KOPPEL, JACOBS, PATRICK & HEYBL, Suite 107, 555 St. Charles Drive, Thousand Oaks, CA, 91360, US

(73) Assignee: NU VENTURE DIVING COMPANY

(21) Appl. No.: 10/927,437

(22) Filed: Aug. 25, 2004

Related U.S. Application Data
(60) Provisional application No. 60/507,665, filed on Sep. 30, 2003.

(51) Int. Cl. B01D 53/22

(52) U.S. Cl. 96/4

(57) ABSTRACT

An apparatus for producing nitrox includes, in one embodiment of the invention, an oxygen enricher to produce oxygen-rich air and a mixing chamber coupled to the oxygen enricher. The mixing chamber is adapted to combine mixing air with the oxygen-rich air to produce nitrox. A method is disclosed that includes removing nitrogen from air to produce an oxygen-nitrogen mixture having an oxygen concentration greater than desired and diluting the oxygen-nitrogen mixture with mixing air having a less than desired oxygen concentration to obtain nitrox having a desired oxygen concentration.

This application claims benefit to a provisional application No. 60/507,665 filed on Sep. 30, 2003.

### BACKGROUND OF THE INVENTION

1. Field of the Invention

This invention relates to gas pressure systems, and more particularly to systems that produce nitrox.

2. Description of the Related Art

Oxygen-rich air (nitrox) and oxygen-nitrogen-third gas mixes (trimix gases) are used in many applications, including scientific, commercial and military systems. One popular application for such gases is diving. By reducing the nitrogen content of air utilized by divers, such as by using nitrox or trimix gas in their breathing apparatus, longer bottom times may be obtained without extending the decompression time necessary after such dives. With longer bottom times, nitrox or trimix gas can be used to increase the safety margin during dives to reduce the risk of decompression sickness.

Unfortunately, the production of nitrox and trimix gas can be hazardous if produced by blending oxygen (O₂) with the other gases due to the highly flammable character of the O₂ component. Also, blending operators must often pass a training and certification process prior to employment for nitrox and trimix production that increases the costs of production.

One solution to reduce the dangers associated with producing nitrox is described in U.S. Pat. Nos. 5,846,291, 5,858,064, and 5,611,845 by W. Delp, II. In each of the patents, a permeable membrane gas separation system separates a nitrogen gas component from compressed air to produce nitrox for later storage and use. Although the systems reduce the flammability problems associated with O₂ and N₂ blending, production repeatability can be a problem because similar input pressures can result in dissimilar oxygen concentrations of the nitrox.

One product that addresses the problems associated with O2 and N2 blending is the DNAx Nitrox Membrane System manufactured by Undersea Breathing Systems, Inc. The system has a semi-permeable gas separation membrane with a nitrogen-discharge backpressure controlled by a needle valve to positively control the oxygen concentration of permeate leaving the membrane. Because the oxygen concentration depends on adjustment of the needle valve, system repeatability is made more difficult. Also, the system downstream of the membrane requires positive and constant pressure to accurately measure the oxygen concentration of the nitrox entering the compressor due to a positive pressure requirement of the oxygen analyzer. When the system is cold and positive pressure has not developed, a high oxygen concentration may develop without the knowledge of the system's operator that is incompatible with standard oil-based compressors.

A need continues to exist for a system to produce nitrox and trimix gas that reduces training requirements and the risks associated with traditional O₂ and N₂ blending techniques, and that enhances repeatability for consumer use.

### SUMMARY OF THE INVENTION

A method for producing nitrox includes removing nitrogen from air to produce an oxygen-nitrogen mixture having an oxygen concentration greater than desired and diluting the oxygen-nitrogen mixture with mixing air having a less than desired oxygen concentration to obtain nitrox having a desired oxygen concentration.

An apparatus is disclosed for producing nitrox that includes an oxygen enricher to produce oxygen-rich air and a first mixing chamber coupled to the oxygen enricher, the mixing chamber adapted to combine mixing air with the oxygen-rich air to produce nitrox.

### BRIEF DESCRIPTION OF THE DRAWINGS

The components in the figures are not necessarily to scale, emphasis instead being placed upon illustrating the principles of the invention. Like reference numerals designate corresponding parts throughout the different views.

FIG. 1 is a perspective view of one embodiment of the invention that has a mixing chamber adapted to receive oxygen-rich air from an oxygen enricher to produce nitrox.

FIG. 2 is a perspective view of a system for producing and storing nitrox that uses the embodiment of the invention illustrated in FIG. 1.

FIG. 3 is a perspective view of the embodiment of the invention illustrated in FIG. 2, with a first trimix adapter coupled downstream of the mixing chamber.

FIG. 4 is a perspective view of the embodiment of the invention illustrated in FIG. 2, with a second trimix adapter coupled downstream of the mixing chamber.

FIG. 5 is a flow diagram illustrating a method of producing nitrox in accordance with one embodiment of the invention.

### DETAILED DESCRIPTION OF THE INVENTION

An apparatus for producing nitrox, in accordance with an embodiment of the invention, has an oxygen enricher coupled to a mixing chamber. The oxygen enricher is, preferably, a canister containing a semi-permeable gas separation membrane (“membrane”) that produces oxygen-rich air at a rate dependent on its input pressure and at a predetermined oxygen concentration. The mixing chamber combines mixing air, preferably ambient air, with the oxygen-rich air to produce nitrox. Because the 1) rate of production of oxygen-rich air is controlled by controlling the input pressure, 2) oxygen-rich air is produced and mixed with ambient air at ambient to slightly negative gage pressure and 3) the oxygen concentration of the oxygen-rich air is reduced to 40% or less prior to compression for storage, nitrox is produced with oxygen concentrations that are repeatable verses input pressure, favorable for use with standard oil-based compressors and without blending oxygen with nitrogen, for a safe and efficient system and method of nitrox production.

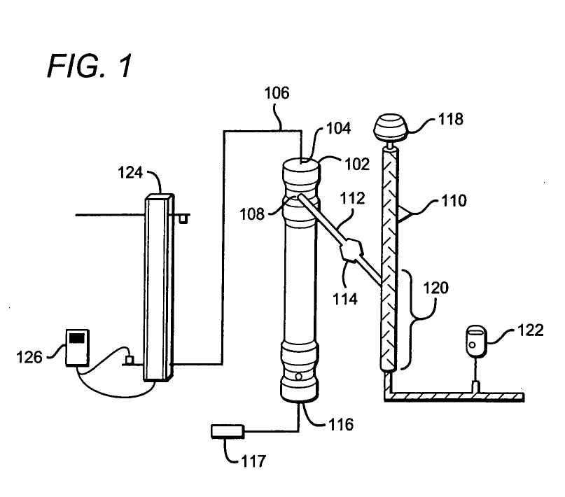

FIG. 1 illustrates one embodiment of the invention that has the membrane coupled between a temperature stabilizer and mixing chamber to produce nitrox from ambient air. The membrane 102 is coupled at its input port 104 to an air-input hose 106 and at its oxygen-output port 108 to a mixing chamber 110 through a membrane-output line 112. The membrane-output line 112 can include a vacuum pump or blower 114 to draw oxygen-rich air at ambient to slightly negative gage pressure from the oxygen-output port 108. A nitrogen-output port 116 from the membrane is either connected to a nitrogen-output orifice 117 that is fixed, or is itself implemented with a fixed orifice, to allow nitrogen-rich air to escape.

More particularly, the membrane 102 has a plurality of hollow tube fibers that allow O₂ to permeate faster than N₂ through their walls. Oxygen-rich air is drawn from the oxygen-output port 108 after permeation through the hollow tubes, while nitrogen-rich air continues through the hollow tubes to exit the membrane 102 at a pressure slightly less than the input pressure through the nitrogen-output port 116. Because of the risk of fire when standard-oil pumps or compressors are used with oxygen concentrations greater than 40%, orifice size is designed and fixed so that the oxygen concentration of the oxygen-rich air is 40-50%, preferably 44%. Examples of a semi-permeable gas separation membrane include any of the PRISM® membranes sold by Air Products and Chemicals, Inc.

Mixing air having a lower-than-desired oxygen concentration, preferably ambient air, enters the mixing chamber 110 through an air intake filter 118 at one end of the chamber. The air intake filter 118 reduces particulate contamination prior to the ambient air's introduction to a mixing portion 120 of the chamber. The mixing portion 120 is preferably a static mixing tube, a tube that has active mixing parts, or a corrugated hose to mix the oxygen-rich air from the membrane 102 with air introduced through the air intake filter 118 to produce nitrox at a desired O₂ concentration. Preferably, the nitrox is a homogenous mix of the ambient and oxygen-rich air that does not exceed an oxygen-concentration of 40% at the membrane's maximum output rating. The nitrox is sampled by a nitrox-oxygen sensor 122 coupled inline and downstream from the mixing portion 120 to determine its oxygen content.

A temperature stabilizer 124, preferably a thermostatically controlled heater with a thermostat control 126, or a radiator or heat exchanger, prevents temperature fluctuations and conditions the air introduced to the membrane 102. Preferably, for an oxygen enricher that is the membrane 102 described above, the air introduced into the input port 104 from the temperature stabilizer 124 is pressurized to 0.4-2.1 mega-Pascal (MPA) with its temperature approximately constant and between 15-54 degrees Celsius. If cooler air is provided to the membrane 102, a lower volume of oxygen-rich air is produced with a higher oxygen concentration. Similarly, if warmer air is input into the membrane 102, a higher volume of oxygen-rich air is produced with a lower oxygen concentration.

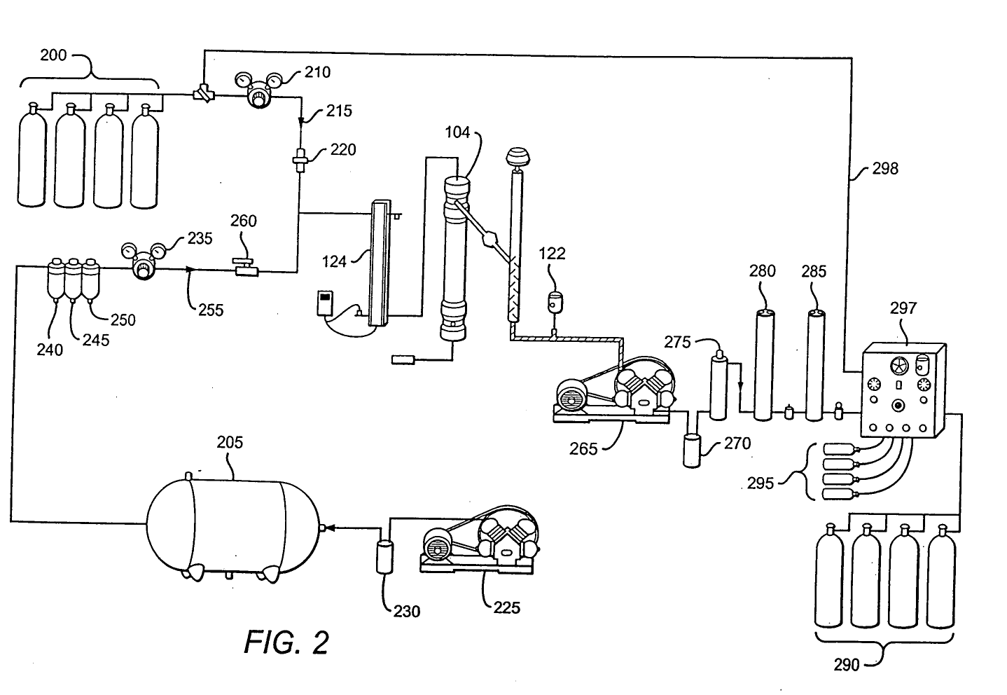

FIG. 2 shows one embodiment of FIG. 1 in further detail. Either high or low-pressure air sources can be provided by high-pressure storage tanks 200 or a low-pressure volume tank 205, respectively. If the high-pressure air sources 200 are used, a high-pressure regulator 210 regulates air stored at approximately 10.3-31.0 MPA down to approximately 0.4-2.1 MPA through a check valve 215 that restricts back flow into the regulator 210. The regulated air is preferably routed through a high-pressure source valve 220 (rated to 2.1 MPA) to the temperature stabilizer 124 prior to its introduction into the membrane 102.

If a low-pressure source is used, the low-pressure tank 205 is fed by a low-pressure compressor 225 through a first cooler 230. While the high-pressure air source preferably contains pre-filtered and grade “E” or better air, the low-pressure compressor 225 provides air that must be filtered from water and oil vapor prior the air's introduction to the membrane 102. Because commercial air filters do not operate as efficiently at elevated temperatures, the first cooler 230 cools the air after heating caused by the low-pressure compressors 225 to enable more efficient coalescing and filtration. The first cooler 230 can be one of many different types of coolers, including a radiator style placed in front of the fan and pulley on the compressor, a radiator style with additional fans, a water/heat exchanger that uses fresh or sea water to cool the air in cooling tubes, or a refrigerated cooling type or swamp cooler heat exchanger that use the dry nitrogen gas expelled from the membrane 102 to create a cooling effect with moisture, without creating a back pressure on the nitrogen-output port 116. The low-pressure volume tank 205 also enables moisture to separate from the air within the tank and accumulate at the bottom of the tank. Air from the low pressure tank 205 is introduced to a low-pressure regulator 235 through coalescing, fine polish and oil vapor removal filters 240, 245, and 250, respectively. The coalescing filter 250 removes moisture and particles larger than approximately 1.0 microns. The fine polish and oil vapor removal filters 245 and 250 remove particles greater than 0.01 microns and oil vapor to 0.003 PPM, respectively, to maintain the life and effectiveness of the membrane 102. The filtered air preferably enters the temperature stabilizer 124 after passing through a second check valve 255 and low-pressure source valve 260. High and low pressure source valves 220, 260 can be ball, gate or solenoid valves. Filtration provided by the coalescing, fine polish and oil vapor removal filters is preferably grade “D” quality or better.

If the nitrox-oxygen sensor 122 indicates that the oxygen-concentration of the nitrox is lower than desired, the user can raise the input pressure until the nitrox-oxygen sensor 122 indicates the desired oxygen concentration. Similarly, lowering the input pressure would result in lowering the indicated oxygen concentration of the nitrox. Preferably, the thermostatically controlled heater 124 is set to a constant value for each use and the input pressure is used to adjust and predict the resulting oxygen concentration of the nitrox.

Nitrox flows past the nitrox-oxygen sensor 122 at ambient to slightly negative gage pressure and is compressed by a nitrox compressor 265. Because typical oil and moisture filters loose their effectiveness or are susceptible to damage at higher temperatures and moisture levels, the nitrox can be cooled by a second cooler 270 and introduced to a condensate separator 275 prior to introduction to breathing air/Nitrox grade filters 280 and 285. Similar to the first cooler 230, the second cooler 270 can be an air cooler, heat exchanger or refrigerated dryer. The nitrox is distributed to large or small volume nitrox-storage tanks 290 and 295 through a gas distribution panel 297. A high-pressure bypass line 298 also allows the gas distribution panel 297 to receive high-pressure air directly from air/nitrox compressor 265 to recharge the high pressure tanks 200.

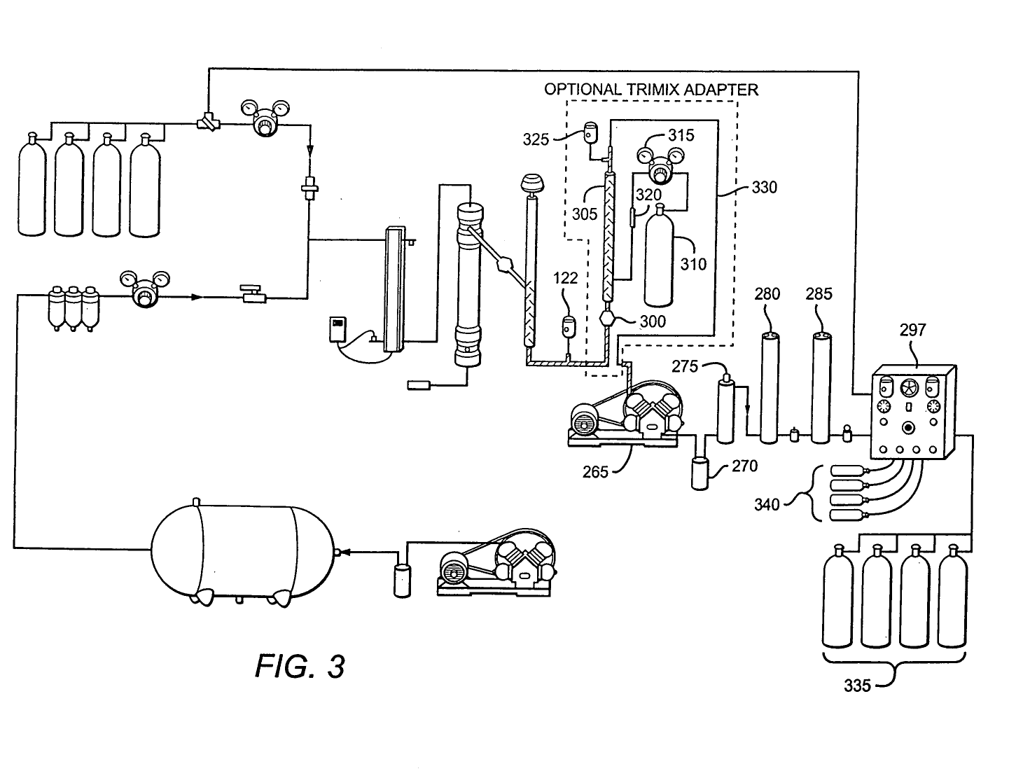

FIG. 3 illustrates the application of the invention to the production of trimix gas in addition to producing nitrox. In this embodiment, prior to introducing the nitrox to the nitrox compressor 265 as in FIG. 2, a blower or fan 300 draws the oxygen-rich air into a second mixing chamber 305 at a low pressure to be mixed with a third gas, preferably Helium (He), that is stored in a third-gas pressure tank 310. The He is regulated down to approximately ambient pressure through a pressure regulator 315, then proceeds through a flow meter 320 for visual indication of He flow to the second mixing chamber 305.

An oxygen sensor 325, preferably coupled inline with the gas stream, is provided downstream of the second mixing chamber 305 to indicate the oxygen concentration of the oxygen-nitrogen-helium trimix gas. By comparing the oxygen contents of the trimix and nitrox gases, the concentration of He in the trimix gas can be calculated. For example, if the indicated oxygen concentration of the nitrox gas is 30%, the calculated nitrogen concentration of the nitrox gas would be approximately 70% (assuming that nitrogen makes up the remainder of gas in the input air to the membrane 102). If the oxygen sensor 325 indicates 15% oxygen in the trimix gas after introduction of helium (a reduction of 50% from that indicated before the introduction of He), the calculated nitrogen concentration would be 35% (70% reduced by 50%). Because the sum of the gas concentrations must equal 100%, the helium concentration of the trimix gas would be calculated at 50% (15% O₂+35% N₂+50% He₂=100% total gas).

A trimix hose 330 carries the trimix to the nitrox compressor 265 for compression and then to the second cooler 270, condensate separator 275 and high-pressure filters 280 and 285 for cooling, condensation and filtering, respectively, prior to storage in large or small volume trimix-storage tanks 335 and 340. The gas distribution panel can be used to distribute the trimix gas for storage.

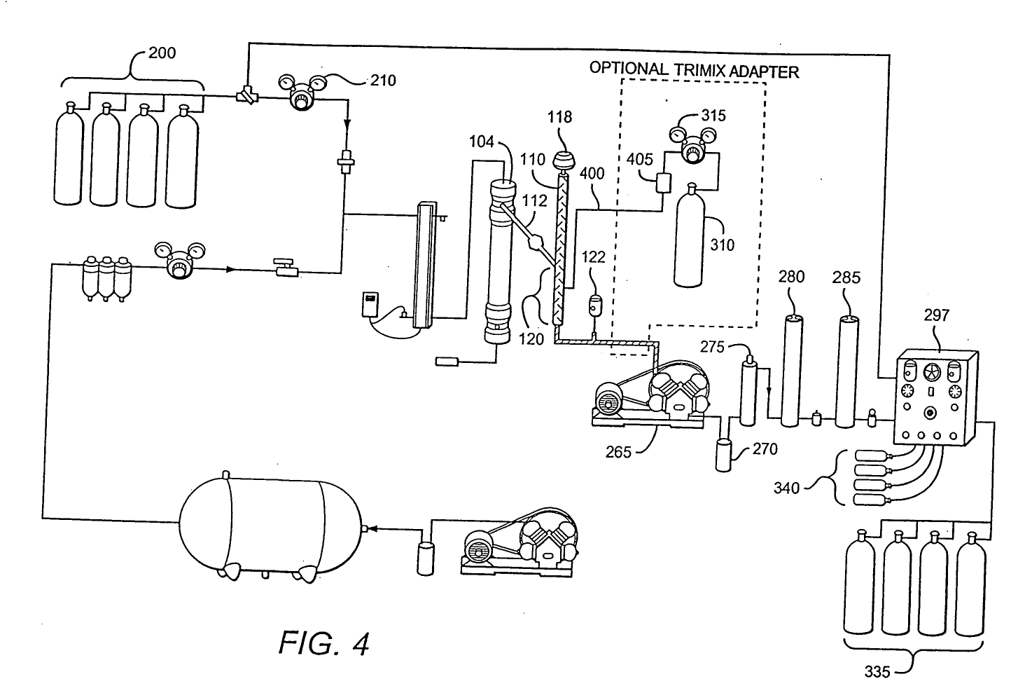

FIG. 4 illustrates the application of the invention to the production of trimix gas without the use of a second mixing chamber 305. Similar to the embodiment illustrated in FIGS. 1 and 2, permeate from the membrane-output line 112 and mixing air through air intake filter 118 are introduced to the mixing chamber 110. In the embodiment illustrated in FIG. 4, the third gas, preferably Helium (He), is supplied to the mixing chamber 110 through a third-gas-input hose 400 coupled to the mixing portion 120. The HE is regulated down from the third-gas pressure tank 310 through the pressure regulator 315 that is coupled to the third-gas-input hose 400. A needle valve 405 is positioned in line between the pressure regulator 315 and the mixing portion 120 to provide further flow control of the He through the third-gas-input hose 400.

During operation, the air/nitrox compressor 265 is turned on and the nitrox-oxygen sensor 122 calibrated to the oxygen concentration of ambient air, or 21%. For a desired He concentration of 50%, the needle valve 405 is opened slowly and adjusted until the indicated oxygen concentration at the nitrox-oxygen sensor 122 is one-half of 21%, or, 10.5%. Permeate from the membrane-output line 112 is introduced to the mixing portion 120 and, if the high-pressure storage tanks 200 are used, the regulator 210 can be adjusted to adjust the input pressure for the membrane 104 until the nitrox-oxygen sensor 122 indicates the desired oxygen concentration of nitrox, typically 18% or 21%. The user can raise the input pressure to increase the oxygen concentration indicated on the nitrox-oxygen sensor 122. Similarly, lowering the input pressure would result in lowering the indicated oxygen concentration of the nitrox for storage.

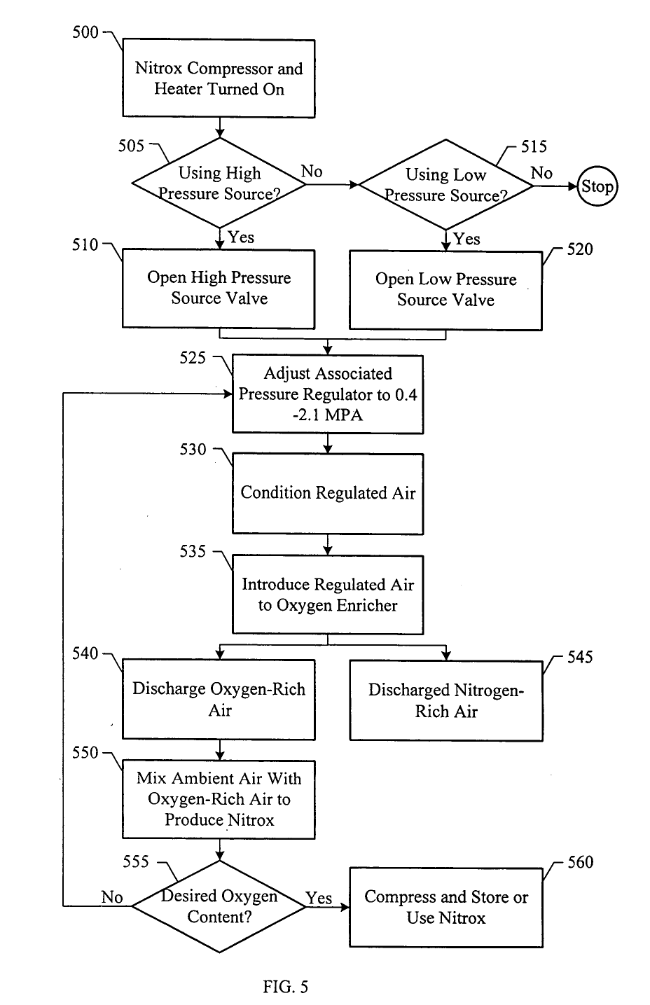

FIG. 5 is a flow diagram of a method of producing nitrox that can be practiced with the system of FIG. 2. The nitrox compressor 265 and temperature stabilizer 124 are turned on (block 500). If the high-pressure source 200 is used (block 505), the high-pressure source valve 220 is opened (block 510). If the low pressure source 205 is used (block 515), the low-pressure source valve 260 is opened (block 520). The applicable pressure regulator 210 or 235 is manually adjusted to set the input pressure within the utilized membrane's operating range, generally between 0.4-2.1 MPA (block 525), and the air is processed by the temperature stabilizer 124 (block 530) and introduced into the membrane 102 (block 535). Oxygen and nitrogen-rich air are discharged from respective ports 108 and 116 (blocks 540, 545) and ambient air is introduced through filter 118 and mixed with the oxygen-rich air to produce nitrox (block 550). The oxygen content of the nitrox is measured by oxygen sensor 122 and, if it is at the desired oxygen concentration (block 555), is distributed for use or storage (block 560). Otherwise, the user increases the input pressure using the associated pressure regulator, if a higher oxygen concentration is desired, or decreases the input pressure if a lower oxygen concentration is desired (block 525).

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

1. A method for producing nitrox, comprising:
removing nitrogen from air to produce an oxygen-nitrogen mixture having an oxygen concentration greater than desired; and
diluting the oxygen-nitrogen mixture with mixing air having a less than desired oxygen concentration to obtain nitrox having a desired oxygen concentration.

2. The method of claim 1 wherein said diluting further comprises:
mixing the oxygen-nitrogen mixture to obtain a homogeneous mix of nitrox.

3. An apparatus for producing nitrox, comprising:
an oxygen enricher to produce oxygen-rich air; and
a first mixing chamber coupled to said oxygen enricher, said mixing chamber adapted to combine mixing air with said oxygen-rich air to produce nitrox.

4. The apparatus of claim 3, wherein said oxygen enricher comprises:
a semi-permeable gas separation membrane to separate air into oxygen enriched and nitrogen-rich air.

5. The apparatus of claim 4, wherein said oxygen enricher produces said oxygen-rich air with an oxygen concentration of between 40-50% during steady-state operation.

6. The apparatus of claim 3, further comprising:
a temperature stabilizer to thermally stabilize input air introduced to said oxygen enricher.

7. The apparatus of claim 6, wherein said temperature stabilizer comprises a heater to heat said air.

8. The apparatus of claim 3, further comprising:
an O₂ sensor coupled in-line and downstream from said mixing chamber to detect the oxygen content of said nitrox.

9. The apparatus of claim 3, further comprising:
a compressor coupled to said mixing chamber to compress said nitrox.

10. The apparatus of claim 9, further comprising:
an oxygen sensor downstream of said compressor to detect the oxygen content of said nitrox.

11. The apparatus of claim 3, further comprising:
a pressure regulator coupled to an input of said oxygen enricher to regulate the pressure of air introduced to said oxygen enricher.

12. The apparatus of claim 11, wherein said pressure regulator comprises a high-pressure regulator for reducing 10.3-31.0 MPA pressurized air to 0.4-2.1 MPA.

13. The apparatus of claim 3, further comprising:
a second mixing chamber coupled to receive the output of said first mixing chamber; and
a gas source connected to introduce an additional gas into said second mixing chamber;
wherein said second mixing chamber mixes said nitrox with said additional gas to produce trimix gas.

14. The apparatus of claim 13, wherein said additional gas comprises helium, said second mixing chamber producing a trimix gas comprising oxygen, helium and nitrogen.

15. The apparatus of claim 3, further comprising:
a gas source connected to introduce an additional gas into said first mixing chamber;
wherein said first mixing chamber mixes said nitrox with said additional gas to produce trimix gas.

16. A method of producing nitrox at a predetermined oxygen concentration, comprising:
separating nitrogen from a first air stream to produce oxygen-rich air;
controlling on input pressure for said nitrogen separation to control a rate of production of said oxygen-rich air; and
mixing a second air stream with said oxygen-rich air to produce nitrox;
wherein the oxygen concentration of said nitrox is controlled by controlling the input pressure.

17. The method of claim 16, further comprising:
thermally conditioning said first air stream.

18. The method of claim 17, further comprising heating said air electronically.

19. The method of claim 16, further comprising:
monitoring an oxygen concentration of said nitrox after said mixing.

20. The method of claim 16, further comprising:
drawing said oxygen-rich air towards said second air stream for mixing.

21. The method of claim 16, further comprising:
drawing said nitrox downstream of said mixing at a pressure less than or equal to ambient pressure.

22. The method of claim 16, further comprising:
mixing a gas stream with said nitrox to produce a trimix gas.

23. A system for creating and storing air to breathe, comprising:
an air storage tank to store air;
an oxygen enricher to produce oxygen-rich air from said stored air;
an air mixer to mix said oxygen-rich air with ambient air to produce nitrox;
a pressure regulator coupled between said air storage tank and said oxygen enricher to control the input pressure to said oxygen enricher; and
a nitrox storage tank coupled downstream of said mixer to store said nitrox;
wherein increasing said input pressure increases the rate of oxygen-rich air production which increases the oxygen concentration of nitrox as measured after said air mixer.

24. The system of claim 23, further comprising:
a heater coupled to said oxygen enricher to heat said stored air prior to its introduction into said oxygen enricher.

25. The system of claim 24, wherein said heater comprises an electric heater to heat said air.

26. An apparatus for producing nitrox, comprising:
an oxygen enricher to separate nitrogen from a first air stream to produce oxygen-rich air;
a pressure regulator to regulate a pressure of said first air stream to control the flow of oxygen-rich air; and
a mixing chamber to mix a second air stream with said oxygen-rich air to produce nitrox;
wherein the oxygen concentration of said nitrox is controlled by controlling the pressure of said first air stream.
